(19) United States
(12) Patent Application Publication
(10) Pub. No.: US 2019/0283607 A1
(43) Pub. Date: Sep. 19, 2019

(54) DISPLAY DEVICE AND ELECTRONIC MIRROR

(71) Applicant: SHARP KABUSHIKI KAISHA, Sakai City, Osaka (JP)

(72) Inventors: TAKEHIRO MURAO, Sakai City, Osaka (JP); RYOH KIKUCHI, Sakai City, Osaka (JP); TAKAYUKI YAMADA, Sakai City, Osaka (JP); TAKEHIKO NAKAGAWA, Sakai City, Osaka (JP); YOSHIMITSU INAMORI, Sakai City, Osaka (JP); NAOKI SHIRAISHI, Sakai City, Osaka (JP)

(21) Appl. No.: 16/465,527

(22) PCT Filed: Nov. 24, 2017
(86) PCT No.: PCT/JP2017/042250

§ 371 Date: May 30, 2019

(30) Foreign Application Priority Data
Dec. 1, 2016 (JP) 2016-234517

(51) Int. Cl. B60K 35/00; G06K 9/00; H04N 13/225; H04N 13/383

(52) U.S. Cl. CPC B60K 35/00; G06K 9/00805; B60K 2370/1529; H04N 13/383; B60R 2300/20; H04N 13/225

(57) ABSTRACT

The present invention enhances instant readability by causing a driver to visually recognize, without a feeling of stranger an image obtained by photographing an area around a vehicle. A display section (11, 12, 13) is provided ahead of a driver, and the display section displays an image, obtained by photographing an area around an automobile (1), so that the image is recognized to be located on a deeper side away from the driver, an amount, by which a visible object is recognized to be located on a deeper side than a display screen, corresponding to a distance which causes the driver to recognize the visible object reflected by a mirror.

### TECHNICAL FIELD

The present invention relates to a display device for an electronic mirror which display device displays an image captured by an in-vehicle camera and an electronic mirror in which the display device is used.

### BACKGROUND ART

An electronic mirror system has recently been developed so that safe driving is supported. The electronic mirror system is configured to cause a display device to display an image which has been obtained by photographing a view of an area behind a vehicle with use of an in-vehicle camera.

According to an image display control device of Patent Literature 1, images captured by two cameras are combined, so that an image of a wide area, whose horizontal angle of view is 180 degrees, behind a vehicle is displayed.

Furthermore, according to the image display control device, in order to give a driver a sense of depth, an image obtained by combining the images captured by two cameras is deformed and displayed as if both mirrors, between which a central mirror is located, of a triple mirror were folded at a given angle with respect to the central mirror.

That is, the image display control device displays a rear center image, which is a planar image whose angle of view is 110 degrees, deforms right and left images with respect to the rear center image into a deformed right surrounding image and a deformed left surrounding image, respectively, by compressing and distorting the right and left images so as to gradually provide the right and left images with an appearance of depth from one end to the rear center image side end of each of the right and left images, and (iii) displays the deformed right surrounding image and the deformed left surrounding image on the right side and the left side, respectively, with respect to the rear center image.

According to Patent Literature 1, the above arrangement allows the driver to recognize that the deformed left surrounding image and the deformed right surrounding image show lateral parts of the vehicle, so that the driver will not lose a sense of direction.

### CITATION LIST

### Patent Literature

[Patent Literature 1] Japanese Patent Application Publication, Tokukai, No. 2003-255925

### SUMMARY OF INVENTION

### Technical Problem

In a case where an image which has been obtained by photographing an area around a vehicle with use of an in-vehicle camera is shown to a driver and the image is a 2D (planar) image, it takes the driver a long time to recognize the image (the image is less instantly readable) due to a great difference in angle of convergence (binocular angle) between when the driver looks carefully ahead of the driver and when the driver looks at a display device. Furthermore, it is difficult for the driver to achieve (i) a sense of distance between visible objects in the image and (ii) a sense of distance between a visible object and a vehicle which the driver is driving. This causes a feeling of strangeness to the driver.

According to the image display control device of Patent Literature 1, the driver can see a state of an area behind the vehicle as if the driver looked in a triple mirror while facing toward the triple mirror. Such an arrangement further allows the driver to feel a sense of depth as compared with a case where an image is constituted only by a 2D image.

Note, however, that the rear center image which is displayed in the image display control device is a 2D image. Note also that the deformed left surrounding image and the deformed right surrounding image are each obtained merely by deforming a 2D image so as to gradually provide the 2D image with an appearance of depth from one end to the rear center image side end of the 2D image. This makes it difficult to understand a distance between visible objects in each of the rear center image, the deformed left surrounding image, and the deformed right surrounding image.

As described above, even an image which is displayed in the image display control device disclosed in Patent Literature still causes a feeling of strangeness to a driver and also fails to solve a problem of an angle of convergence. This does not lead to an improvement in instant readability.

The present invention has been made in view of the problems, and an object of the present invention is to cause a driver to instantly visually recognize, without a feeling of strangeness, an image obtained by photographing an area around a vehicle.

### Solution to Problem

In order to attain the object, a display device in accordance with an aspect of the present invention includes a configuration in which: the display device is provided ahead of a driver, and the display device displays a visible object, which is included in an image obtained by photographing an area around a vehicle, so that the visible object is recognized to be located on a deeper side than a display screen on which to display the image, the deeper side being a side which is away from the driver, an amount, by which the visible object is recognized to be located on the deeper side than the display screen, corresponding to a distance which causes the driver to recognize the visible object reflected by a mirror.

In order to attain the object, a display device in accordance with an aspect of the present invention includes a configuration in which: the display device is provided ahead of a driver, and the display device displays a visible object, which is included in an image obtained by photographing an area around a vehicle, so that the visible object is recognized to be located on a deeper side than a display screen on which to display the image, the deeper side being a side which is away from the driver, an amount, by which the visible object is recognized to be located on the deeper side than the display screen, corresponding to a distance of not less than 12.6 mm.

In order to attain the object, a display device in accordance with an aspect of the present invention includes; an image display section configured to display a right eye image and a left eye image so that a visible object is recognized to be located on a deeper side than a display screen on which to display the image, the deeper side being a side which is away from a driver; and a sensor section configured to specify a location of a face of the driver; and a parallax barrier configured to shield a part of each of the right eye image and the left eye image from light in accordance with the location of the face of the driver, the location having been specified by the sensor section, so that the visible object is recognized to be located on the deeper side than the display screen.

### Advantageous Effects of Invention

An aspect of the present invention brings about an effect of allowing a display of an image which is superior in instant readability and less causes a feeling of strangeness.

### BRIEF DESCRIPTION OF DRAWINGS

FIG. 1 is a view illustrating a state of a driver's seat of a vehicle which is provided with a display device in accordance with Embodiment 1 of the present invention.

FIG. 2 is a top view of a vehicle which is provided with the display device in accordance with Embodiment 1 of the present invention.

FIG. 3 is a block diagram schematically showing an arrangement of an electronic mirror in accordance with. Embodiment 1 of the present invention.

FIG. 4 is a cross-sectional view illustrating a state of a liquid crystal display panel and a parallax barrier during a 3D display in accordance with Embodiment 1 of the present invention.

(a) of FIG. 5 is a view illustrating a line of sight at which a driver is looking forward through a windshield. (b) of FIG. 5 is a view illustrating a line of sight at which a driver is looking backward through a rearview mirror. (c) of FIG. 5 is a view illustrating a line of sight at which a driver is looking at a display device which carries out a 2D display. (d) of FIG. 5 is a view illustrating a line of sight at which a driver is looking at a display device which carries out a 3D display.

FIG. 6 is a view illustrating a line of sight at which a driver is looking at a display device which displays a 3D image.

FIG. 7 is a diagram showing various parameters which are used to display a 3D image.

FIG. 8 is a view illustrating Example 1 of the present invention. (a) of FIG. 8 is a view illustrating a line of sight at which a driver is looking at a display device which displays a pop-up 3D image. (b) of FIG. 8 is a view illustrating a line of sight at which a driver is looking at a display device which displays a 2D image. (c) of FIG. 8 is a view illustrating a line of sight at which a driver is looking at a display device which displays a deep 3D image.

FIG. 9 is a diagram showing parameters which are used to display a 3D image in accordance with Example 1 of the present invention.

FIG. 10 is a diagram showing a relationship in accordance with Example 1 of the present invention among (a) an offset amount, (b) a pop-up amount and an amount of depth, and (c) an amount of discrepancy in convergence adjustment.

FIG. 11 is a diagram showing graphs of a relationship of FIG. 10 between (a) an offset amount of a display image and (b) a pop-up amount and an offset amount.

FIG. 12 is a diagram showing graphs of a relationship of Fi 10 between (a) an offset amount of a display image and (b) an amount of discrepancy in convergence adjustment.

FIG. 13 is a diagram showing experimental results of Example 1 of the present invention.

### DESCRIPTION OF EMBODIMENTS

### Embodiment 1

(Arrangement of Automobile Provided with Electronic Mirror)

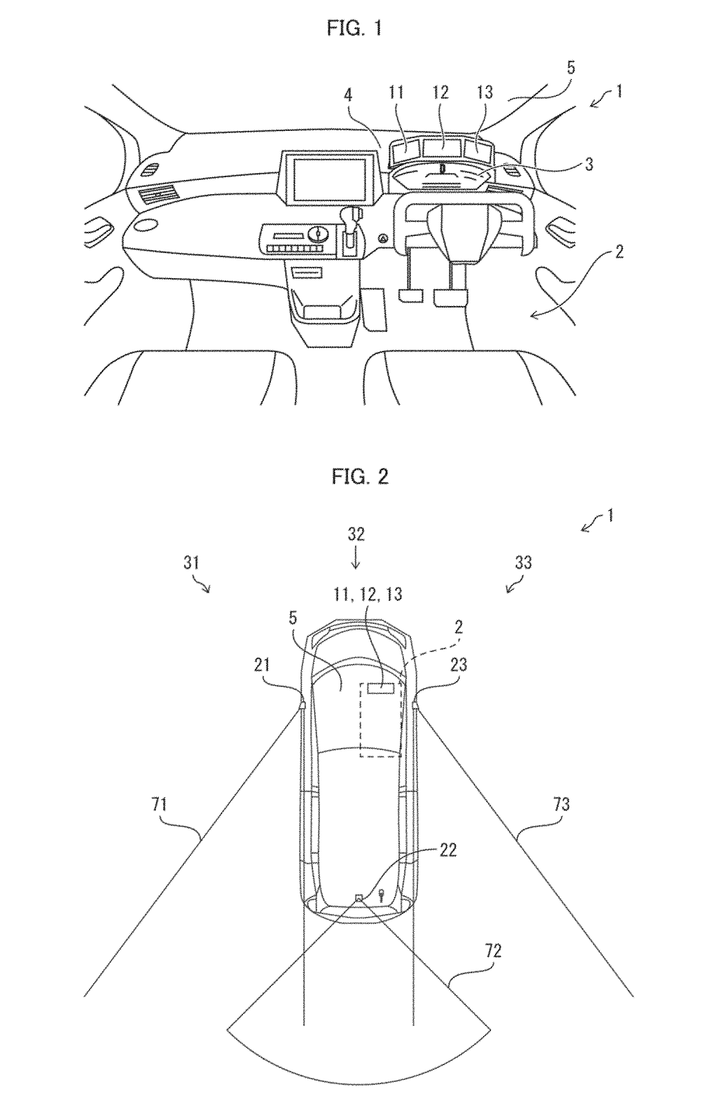

A display device in accordance with Embodiment 1 of the present invention is described below with reference to FIGS. 1 and 2. FIG. 2 is a top view of a vehicle which is provided with the display device in accordance with Embodiment 1 of the present invention. FIG. 1 is a view illustrating a state of a driver's seat of a vehicle which is provided with the display device in accordance with Embodiment 1 of the present invention.

Note that Embodiment 1 describes an example in which a display device in accordance with an embodiment of the present invention is provided in a four-wheeled vehicle, which is an example of a vehicle. Note, however, that the display device in accordance with an embodiment of the present invention can be provided in not only a four-wheeled vehicle but also various vehicles such as a two-wheeled vehicle (e.g., a motorcycle) and a three-wheeled vehicle. Note also that the display device in accordance with an embodiment of the present invention can also be provided in a four-wheeled vehicle of any type, such as a compact car, a medium-sized car, a large-sized car, a truck, or a bus.

Furthermore, Embodiment 1 describes an example in which the display device in accordance with an embodiment of the present invention is used as an electronic mirror. Note, however, that the display device in accordance with an embodiment of the present invention can also be applied to various in-vehicle displays such as a display for a car navigation system.

As illustrated in FIG. 2, an automobile (vehicle) 1 includes an electronic mirror 31 for a left side of the automobile 1, an electronic mirror 32 for a rear center side of the automobile 1, and an electronic mirror 33 for a right side of the automobile 1.

The electronic mirror 31 includes a display section (display device) 11 and a photographing section 21. The electronic mirror 32 includes a display section (display device) 12 and a photographing section 22. The electronic mirror 33 includes a display section (display device) 13 and a photographing section 23.

The electronic mirror 31 carries out a function which substitutes for a function of a left sideview mirror. The electronic mirror 32 carries out a function which substitutes for a function of a rearview mirror. The electronic mirror 33 carries out a function which substitutes for a function of a right sideview mirror. Thus, the automobile 1 does not need to be provided with any of the left sideview mirror, the rearview mirror, and the right sideview mirror.

The photographing sections 21, 22, and 23 are each an in-vehicle camera capable of capturing a moving image. Each of the photographing sections 21, 22, and 23 is, for example, a CCD camera.

The photographing section 21 is provided at a location in the automobile 1 at which location the left sideview mirror is ordinarily provided. The photographing section 21 captures a moving image of a left rear area 71 of the automobile and supplies, to the display section 11, the moving image thus captured in a form of an image signal. Note that the photographing section 21 can be provided at a location in the automobile 1 at which location the photographing section 21 can capture a moving image of the left rear area.

The photographing section 22 is provided in a rear part of a ceiling. The photographing section 22 captures a moving image of a rear center area 72 of the automobile 1, and supplies, to the display section 12, the moving image thus captured in a form of an image signal. Note that the photographing section 22 can be provided at a location in the automobile 1 at which location the photographing section 22 can capture a moving image of the rear center area 72 of the automobile 1. For example, in the automobile 1, the photographing section 22 can be provided on a rear surface in which a rear bumper, a license plate, and the like are provided.

The photographing section 23 is provided at a location in the automobile 1 at which location the right sideview mirror is ordinarily provided. The photographing section 23 captures a moving image of a right rear area 73 of the automobile 1, and supplies, to the display section 13, the moving image thus captured in a form of an image signal. Note that the photographing section 23 can be provided at a location in the automobile 1 at which location the photographing section 23 can capture a moving image of the right rear area.

The display sections 11, and 13 are provided inside the automobile 1. According to Embodiment the display sections 11, 12, and 13 are provided in a driver's seat 2. The display section 11 displays an image, captured by the photographing section 21, of the left rear area 71 of the automobile 1 not in a form of a 2D (planar) image but in a form of a 3D (depth) image. The display section 12 displays an image, captured by the photographing section 22, of the rear center area 72 of the automobile 1 in a form of a 3D (depth) image. The display section 13 displays an image, captured by the photographing section 23, of the right rear area 73 of the automobile 1 in a form of a 3D (depth) image.

Thus, as compared with an arrangement in which an image obtained by photographing an area around the automobile 1 is two-dimensionally displayed, the above arrangement allows a driver to view an image which gives a sense of depth. This allows the driver to easily (i) understand a distance between visible objects in the images shown in the display sections 11, 12, and 13 and achieve a sense of distance between the visible objects and the automobile 1 which the driver himself/herself is driving. The display sections 11, 12, and 13 thus can display an image which less causes a feeling of strangeness.

Note that the 3D (depth) image is an image which, unlike a 2D (planar) image, gives a sense of depth. In particular, the display sections 11, 12, and 13 in accordance with Embodiment 1 display the respective 3D (depth) images each of which not only gives a sense of depth but also causes a driver to feel as if the driver were looking in a mirror. Note that this will be specifically described later in, for example, Example 1.

In the driver's seat 2 of the automobile 1, the display sections 11, 12, and 13 are provided ahead of a driver in a case where the driver sits on the driver's seat. This reduces an amount of shift in line of sight, at which the driver is looking at a visible object (e.g., a road) through a windshield 5, to the display sections 11, 12, and 13. This makes it possible to shorten a time for which the driver inattentively drives so as to view images which are being displayed in the display sections 11, 12, and 13.

Note that the display section 12 is provided at a front center of a driver so as to face the driver when the driver sits on the driver's seat, the display section 11 is provided on the left side of the display section 12 when the driver faces the display section 12, and the display section 13 is provided on the right side of the display section 12 when the driver faces the display section 12.

This allows the driver to intuitively understand (i) that the display section 11 displays a moving image of the left rear area 71 of the automobile 1, that the display section 12 displays a moving image of the rear center area 72 of the automobile 1, and (iii) that the display section 13 displays a moving image of the right rear area 73 of the automobile 1.

The display sections 11, 12, and 13 are embedded in a dashboard. The automobile in accordance with Embodiment 1 also causes a display device 3 to display an instrument panel including various instruments such as a speedometer and an instrument displaying an amount of remaining fuel. The display device 3 is embedded in the dashboard. Then, the windshield 5, the display sections 11, 12, and 13, and the display device 3 are provided so as to be arranged in this order from above to below when viewed by the driver.

Note that the display sections 11, 12, and 13 do not necessarily need to be provided at the respective locations described earlier. The display sections 11, 12 and 13 can be provided at any respective locations provided that the display sections 11, 12 and 13 are visible to the driver. For example, the display sections 11, 12, and 13 can be included in the display device 3. Alternatively, the display sections 11, 12, and 13 can be provided at a location at which a rearview mirror is ordinarily provided, or can be provided in an inner part of a door.

(Arrangements of Electronic Mirrors 31, 32, and 33)

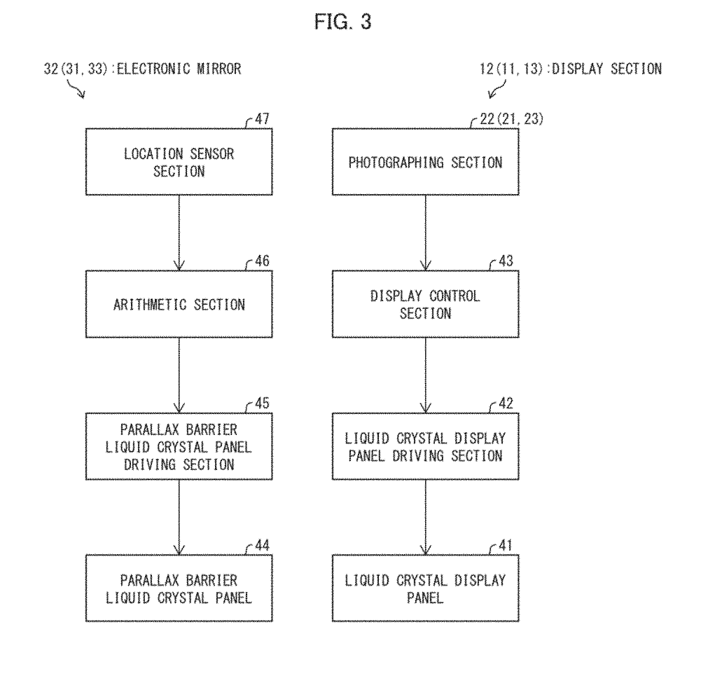

The following description will discuss, with reference to FIG. 3, arrangements of the electronic mirrors 31, 32, and 33. FIG. 3 is a block diagram schematically showing an arrangement of an electronic mirror in accordance with Embodiment 1 of the present invention. Note that Embodiment 1 discusses the arrangement of the electronic mirror 32 out of the electronic mirrors 31, 32, and 33. Since the electronic mirrors 31 and 33 are each identical in arrangement to the electronic mirror 32, a description thereof is omitted here.

Embodiment 1 describes a method for displaying a 3D image with use of a parallax barrier system in which the display sections 11, 12, and 13 employ an eye tracking technique in which (i) a location sensor section 47 is used to recognize a location of a face (eyes) of the driver, and (ii) a location of a parallax barrier is adjusted, in real time, so that the location of the parallax barrier is an optimum location. Note, however, that structures of the display sections 11, 12, and 13 are not limited to such a structure. The display sections 11, 12, and 13 only need to display 3D (depth) images by, for example, a system in which not a parallax barrier but a lens is used, and do not necessarily need to employ the eye tracking technique.

As illustrated in FIG. 3, the electronic mirror 32 includes the location sensor section 47, the photographing section 22, and the display section 12.

The display section 12 includes a liquid crystal display panel (image display section) 41, a liquid crystal display panel driving section 42, a parallax barrier liquid crystal panel 44, a parallax barrier liquid crystal panel driving section 45, an arithmetic section 46, a display control section 43, and a backlight (not illustrated). The backlight is provided on a back surface (surface on a side far from the driver) of the liquid crystal display panel 41.

The photographing section 22 captures a moving image and then supplies, to the display control section 43, the moving image thus captured in a form of an image signal.

In accordance with the image signal which is supplied to the display control section 43, the liquid crystal display panel 41 displays a right eye image (image for the right eye) and a left eye image (image for the left eye).

The parallax barrier liquid crystal panel 44 is provided on a front surface (surface on a side closer to the driver) of the liquid crystal display panel 41. Note that the parallax barrier liquid crystal panel 44 does not necessarily need to be provided at the location described above. The parallax barrier liquid crystal panel 44 can be provided on the back surface of the liquid crystal display panel 41 (between the liquid crystal display panel 41 and the backlight). The parallax barrier liquid crystal panel 44 includes a plurality of electrodes, and, in accordance with a voltage to be applied, forms a parallax barrier in which columns in a transmissive state and columns in a non-transmissive state are provided in a stripe pattern, and makes it possible to switch between transmission and non-transmission of light which exits from a pixel of the liquid crystal display panel 41, which is located on a back side of the parallax barrier liquid crystal panel 44. The parallax barrier liquid crystal panel 44 causes the parallax barrier to shield, from light, a part of each of the right eye image and the left eye image each displayed by the liquid crystal display panel 41, so that a visible object is recognized to be located on a deeper side than a display screen (on a side away from the driver). As a result, a 3D (depth) image is displayed.

The location sensor section 47 includes (i) a photographing section configured to capture an image of the driver and (ii) a location specifying section configured to specify a location of the face of the driver by carrying out image processing with respect to the image captured by the photographing section. The location sensor section 47 which has specified the location of the face of the driver supplies, to the arithmetic section 46, the location thus specified in a form of location information.

In accordance with the location of the face of the driver, which location has been obtained by the location sensor section 47, the arithmetic section 46 determines a voltage application pattern of the parallax barrier liquid crystal panel 44 and supplies, to the parallax barrier liquid crystal panel driving section 45, the voltage application pattern thus determined in a form of voltage application pattern information.

In accordance with the voltage application pattern information, which has been obtained from the arithmetic section 46, the parallax barrier liquid crystal panel driving section 45 applies voltage to the parallax barrier liquid crystal panel 44. This allows the parallax barrier liquid crystal panel 44 to display a parallax barrier which is based on the location of the face of the driver. As a result, the driver who shifts the location of the face can also visually recognize, without fail, a 3D (depth) image to be displayed in the display section 12.

The display control section 43 receives the image signal from the photographing section 22 and generates image data which has been subjected to a process for displaying a 3D (depth) image.

Note here that in order to display a 3D (depth) image, it is necessary to simultaneously display two images for the left eye and the right eye, respectively. Thus, those two images are displayed with use of pixels in every other column. Pixels to be used to display each of the two images account for half of pixels as a whole. Thus, the display control section 43 generates, from the image signal which has been obtained from the photographing section 22, image data in which left eye image data (image data for the left eye) and right eye image data (image data for the right eye) are combined, and supplies the image data thus generated to the liquid crystal display panel driving section 42.

In accordance with the image data which has been obtained from the display control section 43, the liquid crystal display panel driving section 42 displays a left eye image (image for the left eye) and a right eye image (image for the right eye).

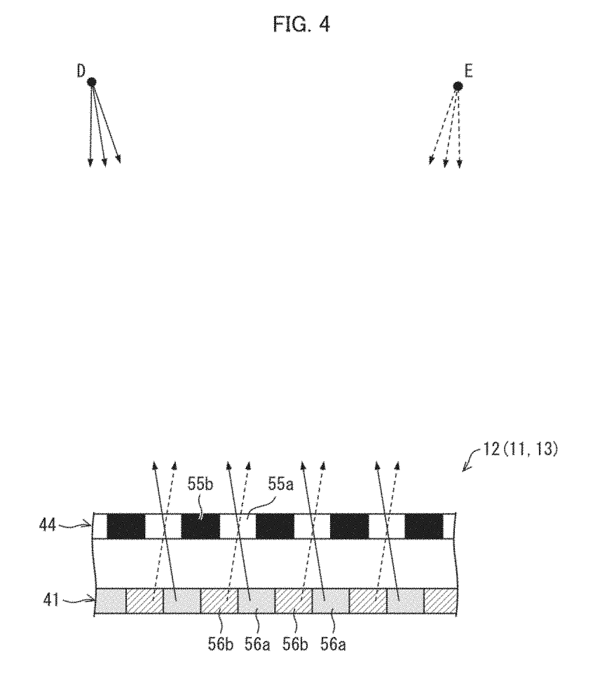

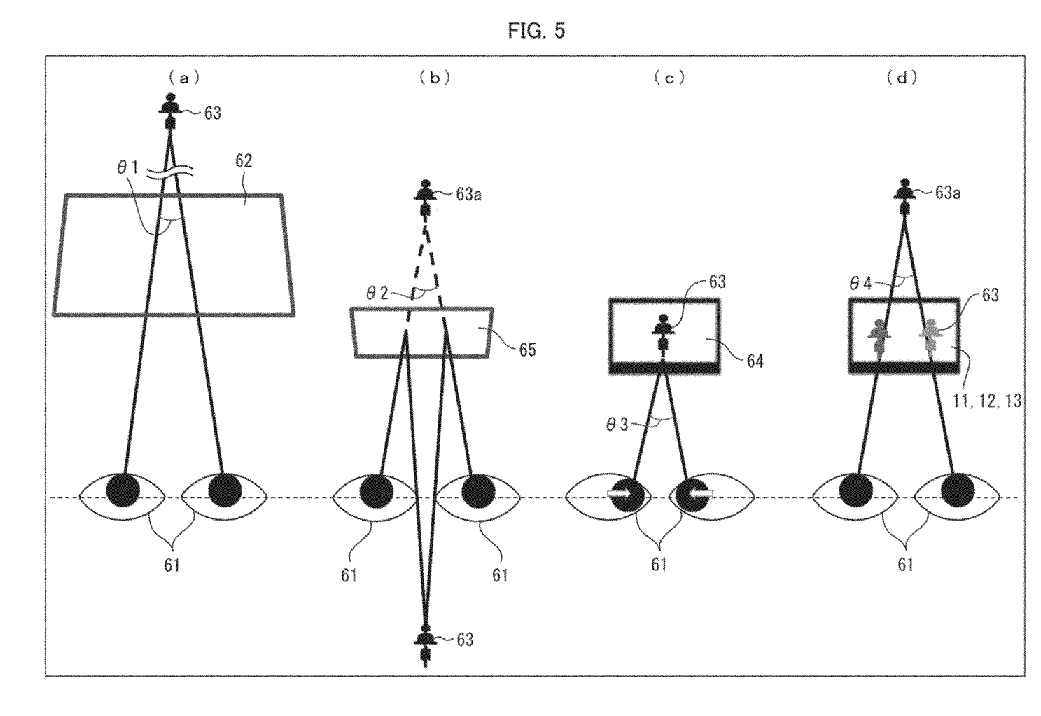

FIG. 4 is a cross-sectional view illustrating a state of the liquid crystal display panel 41 and the parallax barrier liquid crystal panel 44 during a 3D display. According to the 3D display, the liquid crystal display panel 41 alternately displays a left eye image and a right eye image with use of pixels in every other column.

According to the display section 12 of Embodiment 1, the parallax barrier liquid crystal panel 44 is provided on the front surface side (on the driver side) of the liquid crystal display panel 41.

During a 3D (depth) display, the parallax barrier liquid crystal panel 44 is arranged such that columns 55a in a transmissive state and columns 55b in a non-transmissive state are alternately provided. Such an arrangement restricts a direction of light which exits from each pixel column, and consequently restricts a range of a viewing direction (viewing angle) within which range the driver can visually recognize each pixel column. For example, light which has exited from each pixel column 56a, in which to display a first image for the right eye, and then passed through the parallax barrier liquid crystal panel 44 travels toward a given visual point D. Meanwhile, light which has exited from each pixel column 56b, in which to display a second image for the left eye, and then passed through the parallax barrier liquid crystal panel 44 travels toward a given visual point E. The parallax barrier liquid crystal panel 44 prevents the pixel 56b, in which to display the second image for the left eye, from being visually recognized from the visual point D, and prevents the pixel column 56a, in which to display the first image for the right eye, from visually recognized from the visual point E. Furthermore, by driving the parallax barrier liquid crystal panel 44 in accordance with the voltage application pattern which has been calculated by the location sensor section 47 and the arithmetic section 46 and (ii) changing, in real time, a location of a column 55a in a transmissive state and a location of a column. 55b in a non-transmissive state, it is possible to carry out a favorable 3D (depth) display also in a case where the driver is moved.

Note that, though a distance between (a) each of the given visual points D and E and (b) the liquid crystal display panel 41, for example is briefly illustrated in FIG. 4, the distance is greater than that illustrated in FIG. 4.

The display sections 11, 12, and 13 thus carry out a 3D display by causing the right and left eyes to visually recognize respective different images.

The display sections 11, 12, and 13 thus carry out a 3D (depth) display supporting two visual points. Furthermore, the driver can visually recognize a 3D (depth) display by the naked eye and does not need to wear, for example, 3D glasses.

(Main Advantages of Electronic Mirrors 31, 32, and 33)

The display sections 11, 12, and 13 thus adopt the parallax barrier system. This makes it unnecessary to wear 3D glasses (liquid crystal shutter glasses or polarized glasses) configured to visually recognize a 3D (depth) display. This does not hinder the driver from driving and allows the driver to comfortably drive.

Furthermore, examples of a system by which to display a three-dimensional image without using 3D glasses include not only the parallax barrier system but also a system in which a three-dimensional effect is given to an image by providing a lenticular lens in a display screen on which to display the image. Note, however, that provision of a lenticular lens in a display screen results in a constant display of a 3D image.

Meanwhile, the parallax barrier liquid crystal panel 44 which is included in each of the display sections 11, 12, and 13 in accordance with Embodiment 1 can prevent the parallax barrier from being displayed. In this case, by causing a 2D image to be displayed in the liquid crystal display panel 41, the driver can see not a 3D (depth) image but the 2D image. Unlike the case of displaying a 3D image, it is unnecessary to display a left eye image and a right eye image in displaying a 2D image. This makes it possible to display a high-resolution image. The electronic mirrors 31, 32, and 33, each of which thus makes it possible to switch between a 3D (depth) image and a 2D (planar) image in accordance with a driving condition and driver's wishes, are highly convenient.

Note that a method of displaying a 3D image which can be visually recognized by the naked eye can be classified, in accordance with the number of visual points, into a 3D display method supporting two visual points and a 3D display method supporting many visual points. According to a 3D image which is displayed by the 3D display method supporting two visual points, since a resolution of that 3D image can be made ½ with respect to a resolution of a 2D image, a deterioration in resolution of that 3D image with respect to a resolution of a 2D image can be minimized of all the 3D images. Note, however, that a 3D image which is displayed by the 3D display method supporting two visual points is visually recognized in a small area and only from the straight front.

Meanwhile, according to a 3D image which is displayed by the 3D display method supporting any visual points, an increase in number of visual points allows a wider range in which the 3D image is visually recognized. Note, however, that the increase in number of visual points also causes the 3D image to further deteriorate in resolution with respect to a resolution of a 2D image. For example, N visual points cause the 3D image to have a resolution of 1/N with respect to a resolution of a 2D image. Furthermore, the 3D display method supporting many visual points requires images which are as many as visual points. This makes it necessary to provide a large-scale circuit configured to generate a multiple-perspective image.

Note here that, in a case where a display device is applied to an electronic mirror, since it is necessary to faithfully reproduce a rear image, a deterioration in resolution is preferably minimized.

In view of this, according to the electronic ors 31, 32, and 33 in accordance with Embodiment 1, since the display sections 11, 12, and 13 display 3D (depth) images by the 3D display method supporting two visual points, it is possible to minimize a deterioration in resolution. This makes it possible to faithfully reproduce a rear image. With the arrangement, it is possible to display a more natural 3D (depth) image as if the driver were looking in a mirror.

Furthermore, the electronic mirrors 31, 32, and 33, each of which includes the location sensor section 47 and the arithmetic section 46, allows the parallax barrier to be displayed at an optimum location in accordance with the location of the face of the driver. This allows the driver to constantly visually recognize an optimum 3D (depth) image whose deterioration in resolution is minimized.

(Visual Distraction Reducing Effect)

Furthermore, the electronic mirrors 31, 32, and 33 make it possible to bring about an effect of reducing visual distraction. The following description will discuss, with reference to FIG. 5, a visual distraction reducing effect which is brought about by the electronic mirrors 31, 32, and 33 in accordance with an embodiment of the present invention.

(a) of FIG. 5 is a view illustrating a line of sight at which a driver is looking forward through a windshield. (b) of FIG. 5 is a view illustrating a line of sight at which a driver is looking backward through a rearview mirror. (c) of FIG. 5 is a view illustrating a line of sight at which a driver is looking at a display device which carries out a 2D display. (d) of FIG. 5 is a view illustrating a line of sight at which a driver is looking at a display device which carries out a 3D display.

Examples of a state in which a driver is inattentive while driving an automobile include a so-called visual distraction state. Visual distraction refers to a state in which a driver is inattentive while looking away from a road ahead.

This visual distraction is a state in which eyes of a driver are being shifted from a road ahead to various indications in a driver's seat, i.e., a so-called inattentive driving state (a state in which the driver is looking aside while driving). A time for which the driver is looking aside is divided into the following three stages: (a1) a stage at which a driver's line of sight is shifted from the road ahead; (a2) a stage at which the eyes focusing on a distant place are adjusted so as to focus on a place close to the driver; and (a3) a stage at which the driver reads the details of the indications.

Thus, in order to reduce the time for which the driver is looking aside, it is necessary to enhance instant readability by taking a step(s) of, for example, (a1) reducing a distance which the driver's line of sight is shifted, (a2) reducing a convergence adjustment time, which is a focus adjustment time, and/or (a3) devising, for example, the size, a character font, and/or a layout of the details of the indications so that the details of the indications can be understood at a glance.

The following description explains that the visual point adjustment time of (a2) can be reduced by reducing the convergence adjustment time.

As illustrated in (a) of FIG. 5, the driver who is not looking aside looks at a visible object 63 ahead (e.g., a road, a pedestrian, or an automobile) through a windshield 62. In this case, the driver is looking at the visible object 63 which is relatively far from the driver, and respective lines of sight of both eyes 61 are relatively parallel to each other. In this case, an angle of convergence θ1, which is an angle formed by the both eyes 61 and the visible object 63 is relatively small. Furthermore, assuming that a distance from the both eyes 61 to the visible object 63 is a convergence distance, the convergence distance is relatively long.

As illustrated in (b) of FIG. 5, in order to look at the visible object 63 reflected by a rearview mirror 65 (a left sideview mirror or a right sideview mirror), the driver adjusts the focus of his/her eyes to the visible object 63 reflected by the rearview mirror 65 and looks at a virtual image 63a of the visible object 63 reflected by the rearview mirror 65. In this case, a convergence distance, which is a distance from the both eyes 61 of the driver to the visible object 63 reflected by the rearview mirror 65 is relatively long, and the driver looks at a place which is more distant than the rearview mirror 65. Thus, an angle of convergence θ2, which is an angle formed by the both eyes 61 and the virtual image 63a of the visible object 63 reflected by the rearview mirror 65, is as small as the angle of convergence θ1.

As described above, in a case where a line of sight at which the driver is looking forward through the windshield 62 as illustrated in (a) of FIG. 5 are shifted to the visible object 63 reflected by the rearview mirror 65 as illustrated in (b) of FIG. 5, the line of sight is shifted a long distance, but the pupils of the both eyes 61 are less close to each other, and the angle of convergence θ2 is as small as the angle of convergence θ1. This allows a reduction in convergence adjustment time during which the driver adjusts the angle of convergence θ1 to the angle of convergence θ2. As a result, the driver looks aside for a shorter time.

As illustrated in (c) of FIG. 5, in order to, for example, look at the visible object 63 displayed in a display device 64 which is embedded in a dashboard and displays a 2D image, the driver adjusts the focus of his/her eyes to the visible object 63 displayed in a display screen of the display device 64 and looks at the visible object 63 displayed in the display device 64. In this case, a convergence distance, which is a distance from the both eyes 61 of the driver to the visible object 63 displayed in the display device 64, coincides with a distance from the both eyes 61 to the display screen of the display device 64. Thus, in this case, the convergence distance is shorter than in a case where the driver is looking at the visible object ahead through the windshield 62 and in a case where the driver is looking at the visible object reflected by the rearview mirror 65.

Thus, in a case where the line of sight at which the driver is looking forward through the windshield 62 as illustrated in (a) of FIG. 5 are shifted to the visible object 63 which is shown on the display screen of the display device 64 as illustrated in (c) of FIG. 5, the line of sight is shifted a long distance, and the pupils of the both eyes 61 come closer to each other. This causes an angle of convergence θ3, which is an angle formed by the both eyes 61 and the visible object 63 displayed in the display device 64, to be greater than the angle of convergence θ1. Thus, the convergence adjustment time during which the driver adjusts the angle of convergence to the angle of convergence θ3 is made longer accordingly. As a result, the driver looks aside for a longer time.

Meanwhile, in the case of a display device which carries out a 3D (depth) display, as illustrated in (d) of FIG. 5, the driver adjusts the focus of his/her eyes to the visible object 63 displayed in the display sections 11, 12, and 13, and recognizes the visible object 63 as the virtual image 63a of the visible object 63 displayed in the display sections 11, 12, and 13. In this case, the display sections 11, 12, and 13 display the visible object 63 so that the virtual image 63a of the visible object 63 is recognized to have a depth.

In this case, a convergence distance, which is a distance from the both eyes 61 of the driver to the virtual image 63a of the visible object 63 displayed in the display sections 11, 12, and 13, is longer than in a case where the driver looks at the visible object 63 which is shown in the display device 64 which carries out a 2D display. In this case, the driver looks at a place which is more distant than the display sections 11, 12, and 13. This causes an angle of convergence θ4, which is an angle formed by the both eyes 61 and the virtual image 63a of the visible object 63 displayed in the display sections 11, 12, and 13, to be smaller than the angle of convergence θ3.

As described above, in a case where the line of sight at with which the driver is looking forward through the windshield 62 as illustrated in (a) of FIG. 5 are shifted to the visible object 63 displayed in the display sections 11, 12, and 13 as illustrated in (d) of FIG. 5, the line of sight is shifted a long distance, but the pupils of the both eyes 61 are less close to each other, and the angle of convergence θ4 is smaller than the angle of convergence θ3. This allows a reduction in convergence adjustment time during which the driver adjusts the angle of convergence θ1 to the angle of convergence θ4. As a result, the driver looks aside for a shorter time.

The visible object 63 is thus displayed in the display sections 11, 12, and 13 so that the virtual image 63a of the visible object 63 in images captured by the photographing sections 21, 22, and 23 is recognized to be located on a deeper side than the display screen of the display sections 11, 12, and 13 (on a side away from the driver).

With the arrangement, when the driver who has been looking at a view ahead shifts his/her line of sight to the display screen of the display sections 11, 12, and 13, the driver visually recognizes the virtual image 63a of the visible object 63 in the images shown in the display sections 11, 12, and 13. This allows a smaller change in angle of convergence. Thus, the convergence adjustment time which is required when the driver's line of sight is shifted can be made shorter. This allows enhancement of instant readability.

Furthermore, according to the electronic mirrors 31, 32, and 33, by expressing a sense of depth, it is possible to provide an image which looks as if the image were looked at in a mirror. This allows a reduction in feeling of strangeness which feeling is caused while the driver is looking at the display device. The description of Embodiment 1 focuses on a case where the display sections 11, 12, and 13 are applied to electronic mirrors. Note, however, that the display sections 11, 12, and 13, which allow a reduction in change in angle of convergence, are applicable not only to the electronic mirrors but also to, for example, a display device which displays an image obtained by photographing a view ahead.

(3D Image)

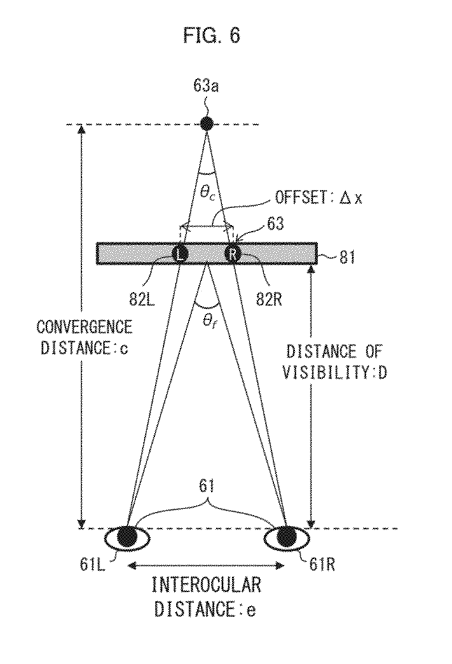

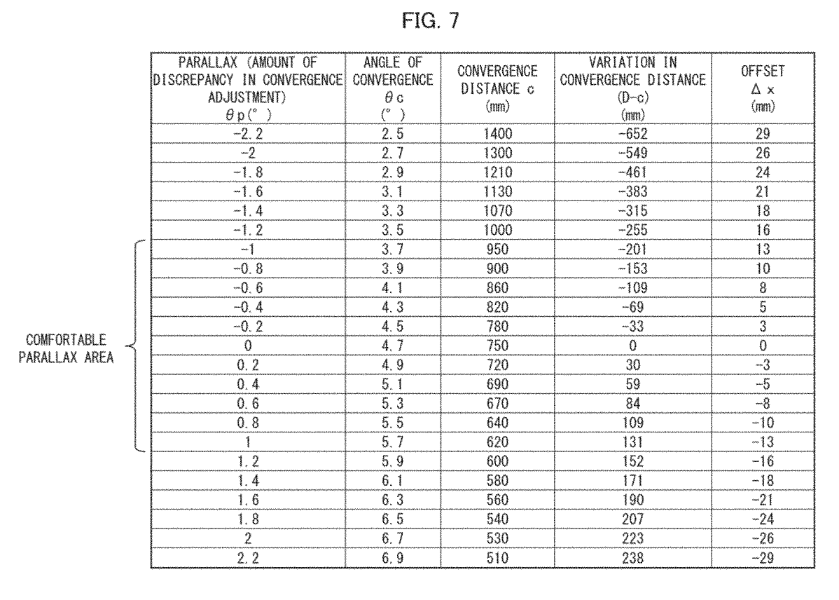

The following description will discuss a 3D image with reference to FIGS. 6 and 7.

FIG. 6 is a view illustrating a line of sight at which a driver is looking at a display section 81 which displays a 3D image. FIG. 7 is a diagram showing various parameters which are used to display a 3D image.

As illustrated in FIG. 6, a distance between a left eye 611, and a right eye 61R of the driver is referred to as an interocular distance, a distance from the both eyes 61 to a display screen of the display section 81 is referred to as a distance of visibility D, a distance from the both eyes 61 to a location of the visible object 63 which is displayed in the display section 81 (the virtual image 63a which causes the visible object 63 to be perceived as being present) is referred to as a convergence distance c, and an angle formed by the both eyes 61 and the virtual image 63a of the visible object is referred to as an angle of convergence θc. The visible object 63 includes a left eye image which is displayed in a left eye pixel 82L and (ii) a right eye image which is displayed in a right eye pixel 82R.

In the display screen, (i) the left eye pixel 82L in which the left eye image which shows the visible object 63 is displayed and (ii) the right eye pixel 82R in which the right eye image which shows the visible object 63 is displayed are provided. A distance between the left eye pixel 82L and the right eye pixel 82R is referred to as an offset Δx, and an angle formed by (a) the middle between the left eye pixel 82L and the right eye pixel 82R and (b) the both eyes 61 is referred to as an angle θf. Furthermore, a parallax Op is expressed by θc−θf and is referred to as an amount of discrepancy in convergence adjustment. In this case, a case where the virtual image 63a is recognized to be located on a side of the display screen of the display section 81 which side is closer to the driver is referred to as a positive state (a state in which a pop-up 3D image is being displayed), and a case where the virtual image 63a is recognized to be located on a deeper side than the display screen of the display section 81 (on a side away from the driver) is referred to as a negative state (a state in which a deep 3D image is being displayed).

The distance of visibility D between the display screen of the display section 81 and the both eyes 61 is set at 750 mm.

In a case where a 3D image in which binocular parallax is employed is displayed, a visible object is perceived to be present in a place different from the display screen. Thus, though the focus of the both eyes 61 is adjusted to the display screen, the visible object is recognized to be located not on the display screen but on a side of the display screen which side is closer to the driver or on a deeper side than the display screen. This causes discrepancy between a focal distance (=the distance of visibility D) and the convergence distance c. Such discrepancy cannot occur in the real world. Thus, in a case where a place at which the visible object which is being displayed in the display screen is perceived is too distant from the display screen, a person who visually recognizes an image feels visual fatigue and feels discomfort.

As illustrated in FIG. 7, a parallax θp of not less than −1° and not more than 1° is considered to be an area in which comfortable visual recognition by many people can be achieved.

Thus, by carrying out a 3D (depth) display of a visible object so that the parallax θp is not less than −1° and less than 0°, the display sections 11, 12, and 13 also allow a driver to comfortably recognize the visible object as if the driver were looking in a mirror.

### Example 1

In a case where 3D (depth) images are displayed in the display sections 11, 12, and 13 so that a visible object is perceived to be located on a deeper side than a display screen, it is possible to give a driver a feeling as if the driver were looking in a mirror. In order to give a driver a feeling as if the driver were looking in a mirror, it is important what depth to give a visible object so as to carry out a 3D (depth) display.

In view of the above, an experiment for evaluating an amount of depth which amount causes an actual sense of depth was carried out by changing an amount of depth of 3D (depth) images displayed by the display sections 11, 12, and 13.

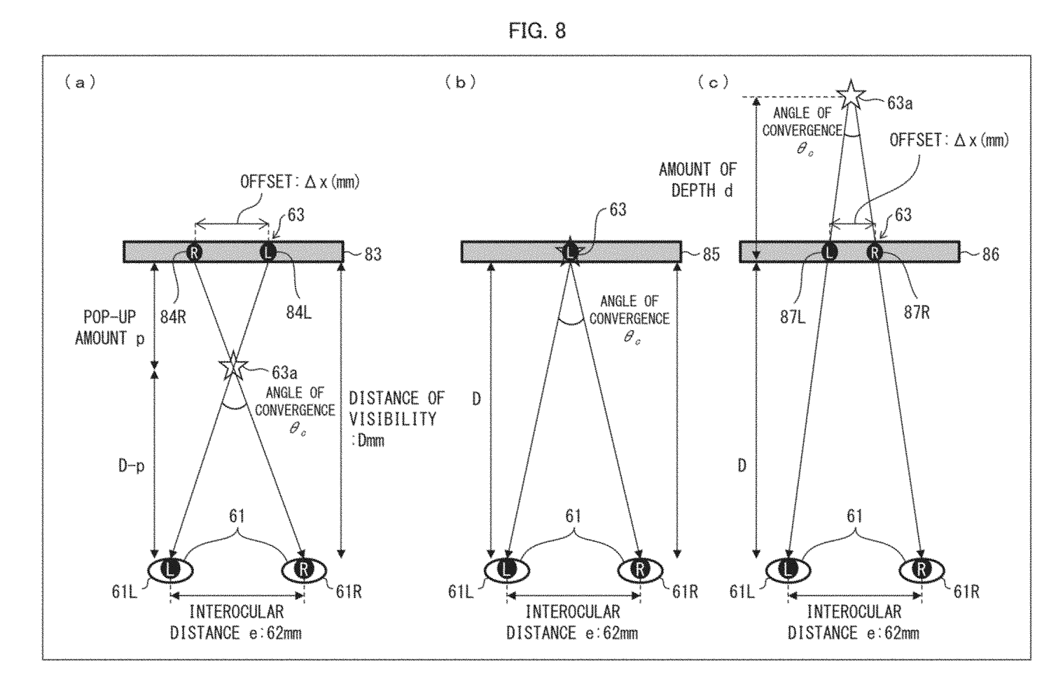

(a) of FIG. 8 is a view illustrating a line of sight at which a driver is looking at a display device 83 which displays a pop-up 3D image. (b) of FIG. 8 is a view illustrating a line of sight at which a driver is looking at a display device 85 which displays a 2D image. (c) of FIG. 8 is a view illustrating a line of sight at which a driver is looking at a display device 86 which displays a deep 3D image.

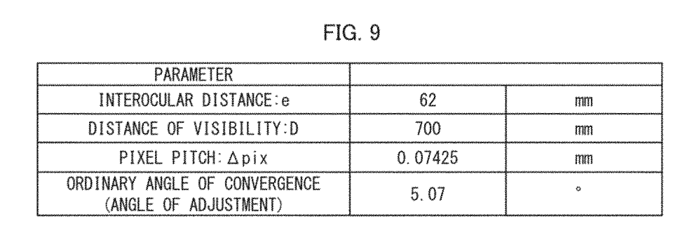

FIG. 9 is a diagram showing parameters which are used to display a 3D image in accordance with Example 1.

An interocular distance e was set at 62 mm, the distance of visibility D, which is a distance from the both eyes 61 to a display screen of the display device 83, a display screen of the display device 85, or a display screen of the display device 86 was set at 700 mm, pixel pitch of each of the display devices 83, 85, and 86 was set at 0.07425 mm, and an ordinary angle of convergence (angle of adjustment) was set at 5.07°. Note here that the ordinary angle of convergence refers to an angle of convergence during a display of a 2D image. Furthermore, the display devices 83, 85, and 86 were each a 6.4-type FHD (1920×1080×RGB pixels).

A pop-up amount in which a pop-up 3D image pops up from the display screen in which the visible object 63 is displayed is denoted as See a) of FIG. 8). An amount of depth of a deep image from the display screen in which the visible object 63 is displayed is denoted as d (see (c) of FIG. 8).

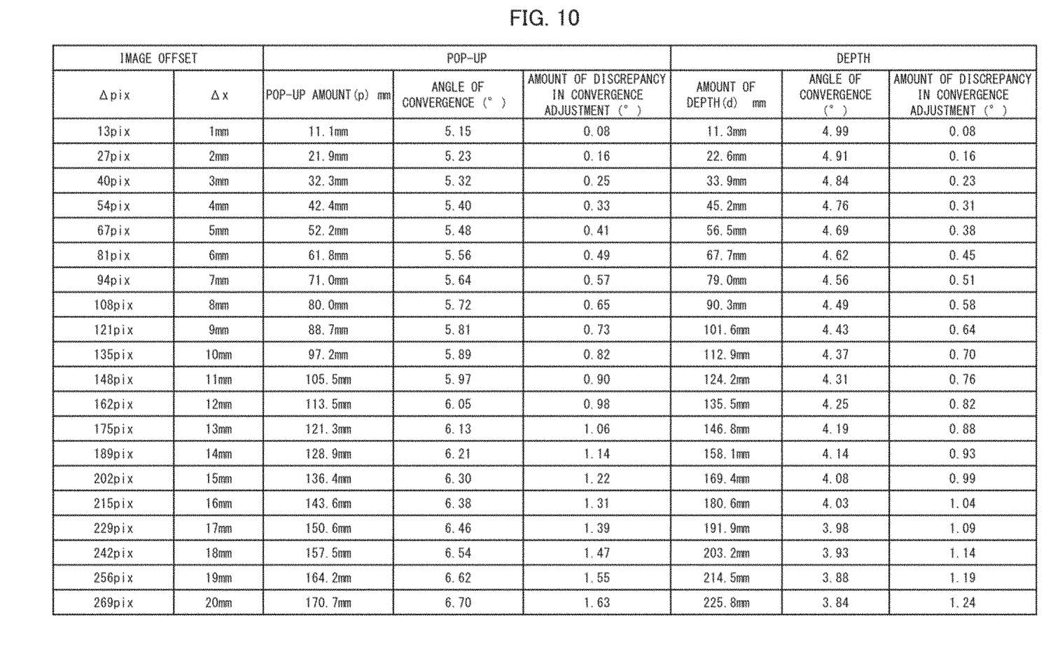

FIG. 10 is a diagram showing a relationship among an offset amount, (b) a pop-up amount and an amount of depth, and (c) an amount of discrepancy in convergence adjustment.

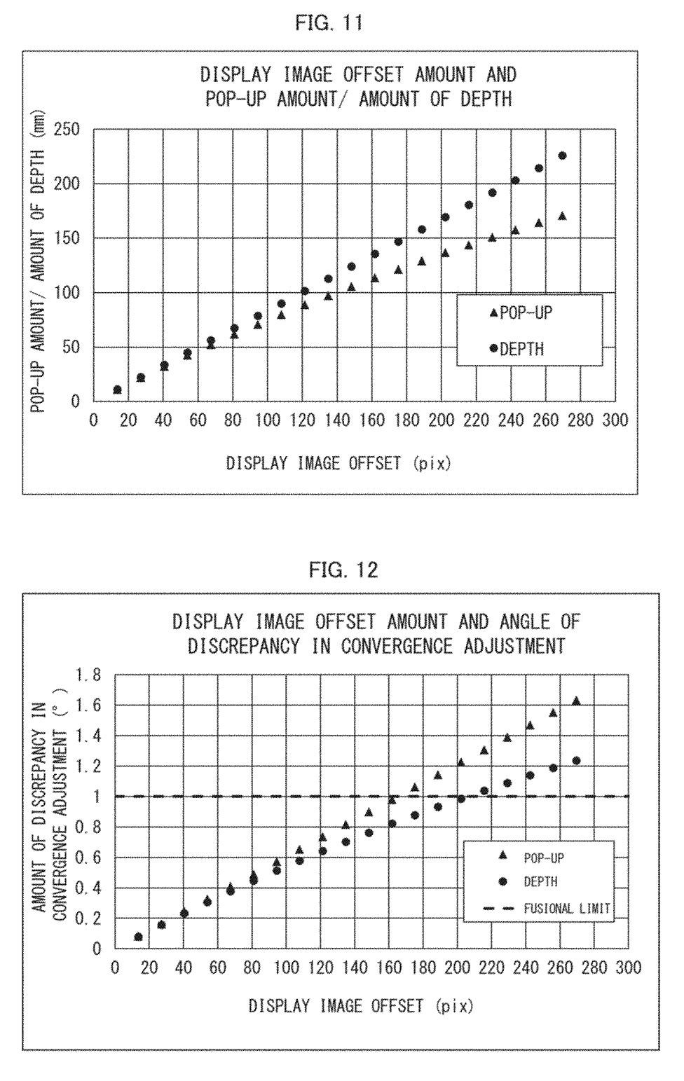

FIG. 11 is a diagram showing graphs of a relationship of FIG. 10 between (a) an offset amount of a display image and (b) a pop-up amount and an offset amount.

FIG. 12 is a diagram showing graphs of a relationship of FIG. 10 between (a) an offset amount of a display image and (b) an amount of discrepancy in convergence adjustment.

Six subjects A1 to A6 were subjected to an evaluation, by an experiment with various parallaxes, of at what point a subject starts to feel that a 3D display has a sense of depth as compared with a 2D display.

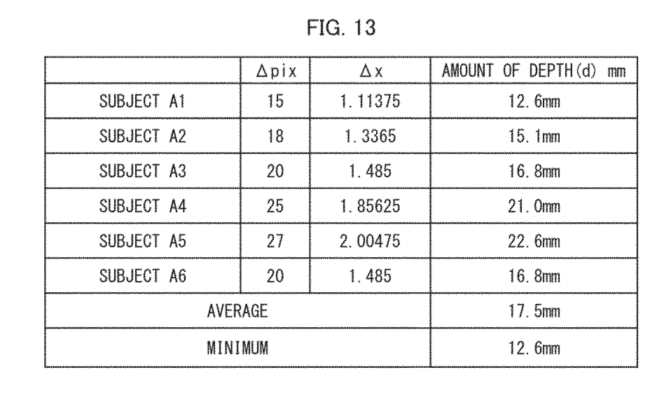

FIG. 13 is a diagram showing experimental results of Example 1.

As shown in FIG. 13, an amount of depth d at which amount the subject A1 starts to feel that the 3D display has a sense of depth was 12.6 mm. An amount of depth d at which amount the subject A2 starts to feel that the 3D display has a sense of depth was 15.1 mm. Similarly, an amount of depth d at which amount the subject A3 starts to feel that the 3D display has a sense of depth was 16.8 mm, an amount of depth d at which amount the subject A4 starts to feel that the 3D display, has a sense of depth was 21.0 mm, an amount of depth d at which amount the subject A5 starts to feel that the 3D display has a sense of depth was 22.6 mm, and an amount of depth d at which amount the subject A6 starts to feel that the 3D display has a sense of depth was 16.8 mm.

An average of the amounts of depth d at which amounts the respective subjects A1 to A6 feel that the 3D display has a sense of depth was 17.5 mm smallest value of the amounts of depth d at which amounts the respective subjects A1 to A6 feel that the 3D display has a sense of depth was 12.6 mm.

The above description shows that, in a case where 3D images are displayed in the display sections 11, 12, and 13 so that an amount of depth d of not less than 17.5 mm is achieved, unlike a case where 2D image is displayed, a driver can visually recognize an image which has a sense of depth. This reveals that it is possible to show a 3D (depth) image to a driver as if the driver were looking in a mirror.

Furthermore, it is also shown that, at least in a case where 3D images are displayed in the display sections 11, 12, and 13 so that an amount of depth d of not less than 12.6 mm is achieved, unlike a case where 2D image is displayed, a driver may be able to visually recognize an image which has a sense of depth.

In other words, the experiment carried out in Example 1 can be said to have made it clear that, in order to show a visible object to a driver as if the driver were looking in a mirror, it is necessary for a visible object to have an amount of depth of at least 12.6 mm.

[Recap]

A display device in accordance with a first aspect of the present invention includes a configuration in which: the display device is provided ahead of a driver, and the display device displays a visible object, which is included in an image obtained by photographing an area around a vehicle, so that the visible object is recognized to be located on a deeper side than a display screen on which to display the image, the deeper side being a side which is away from the driver, an amount, by which the visible object is recognized to be located on the deeper side than the display screen, corresponding to a distance which causes the driver to recognize the visible object reflected by a mirror.

As compared with an arrangement in which an image obtained by photographing an area around a vehicle is two-dimensionally displayed, the above arrangement allows the driver to more easily achieve a sense of distance from the visible object in the image. In particular, according to the arrangement, the depth corresponds to a distance which causes the driver to recognize the visible object reflected by a mirror. Thus, the driver can recognize the visible object while having a feeling as if the driver were looking in the mirror. This makes it possible to display an image which causes no feeling of strangeness and is superior in instant readability.

A display device in accordance with a second aspect of the present invention includes a configuration in which: the display device is provided ahead of a driver, and the display device displays a visible object, which is included in an image obtained by photographing an area around a vehicle, so that the visible object is recognized to be located on a deeper side than a display screen on which to display the image, the deeper side being a side which is away from the driver, an amount, by which the visible object is recognized to be located on the deeper side than the display screen, corresponding to a distance of not less than 12.6 mm. The above arrangement allows the driver to visually recognize an image which looks as if the visible object were reflected in a mirror. This may make it possible to display an image which causes no feeling of strangeness and is highly instantly readable.

In a third aspect of the present invention, a display device is preferably arranged such that, in the second aspect, the amount corresponds to a distance of not less than 17.5 mm. The above arrangement allows the driver to more reliably visually recognize an image which looks as if the visible object were reflected in a mirror. This may make it possible to display an image which causes no feeling of strangeness and is highly instantly readable.

In a fourth aspect of the present invention, a display device is preferably arranged, in any one of the first through third aspects, to further include: an image display section configured to display a right eye image and a left eye image of the visible object; and a parallax barrier configured to shield a part of each of the right eye image and the left eye image from light so that the visible object is recognized to be located on the deeper side than the display screen. The above arrangement makes it possible to switch between (a) a display of an image which causes the visible object to be recognized to be located on the deeper side than the display screen and (b) a display of a 2D (planar) image. This makes it possible to obtain a highly convenient display device.

A display device in accordance with a fifth aspect of the present invention includes: an image display section configured to display a right eye image and a left eye image so that a visible object is recognized to be located on a deeper side than a display screen on which to display the image, the deeper side being a side which is away from a driver; and a sensor section configured to specify a location of a face of the driver; and a parallax barrier configured to shield a part of each of the right eye image and the left eye image from light in accordance with the location of the face of the driver, the location having been specified by the sensor section, so that the visible object is recognized to be located on the deeper side than the display screen.

As compared with an arrangement in which an image obtained by photographing an area around a vehicle is two-dimensionally displayed, the above arrangement allows the driver to more easily achieve a sense of distance from the visible object in the image. Furthermore, since the parallax barrier is displayed in accordance with the location of the face of the driver, the driver can always visually recognize the visible object which allows the driver to easily achieve a sense of distance. This makes it possible to display an image which causes no feeling of strangeness and is superior in instant readability.

An electronic mirror in accordance with a sixth aspect of the present invention includes: a display device in accordance with the fourth aspect or the fifth aspect; and a photographing section configured to (i) capture an image of a rear center, a left rear, or a right rear of a vehicle and (ii) supply the image thus captured to the display device.

The above arrangement makes it possible to obtain an electronic mirror which makes it possible to show, to the driver, an image which causes no feeling of strangeness and is highly instantly readable.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Automobile (vehicle)
2 Driver's seat
5, 62 Windshield
11, 12, 13 Display section (display device
21, 22, 23 Photographing section
31, 32, 33 Electronic mirror
41 Liquid crystal display panel (image display section
47 Location sensor section
63 Visible object
63a Visible object (virtual image)
65 Rearview mirror

1. A display device comprising a configuration in which:
the display device is provided ahead of a driver, and
the display device displays a visible object, which is included in an image obtained by photographing an area around a vehicle, so that the visible object is recognized to be located on a deeper side than a display screen on which to display the image, the deeper side being a side which is away from the driver,
an amount, by which the visible object is recognized to be located on the deeper side than the display screen, corresponding to a distance which causes the driver to recognize the visible object reflected by a mirror.

2. A display device comprising a configuration in which:
the display device is provided ahead of a driver, and
the display device displays a visible object, which is included in an image obtained by photographing an area around a vehicle, so that the visible object is recognized to be located on a deeper side than a display screen on which to display the image, the deeper side being a side which is away from the driver,
an amount, by which the visible object is recognized to be located on the deeper side than the display screen, corresponding to a distance of not less than 12.6 mm.

3. The display device as set forth in claim 2, wherein the amount corresponds to a distance of not less than 17.5 mm.

4. A display device as set forth in claim 1, further comprising:
an image display section configured to display a right eye image and a left eye image of the visible object; and
a parallax barrier configured to shield a part of each of the right eye image and the left eye image from light so that the visible object is recognized to be located on the deeper side than the display screen.

5. A display device comprising:
an image display section configured to display a right eye image and a left eye image so that a visible object is recognized to be located on a deeper side than a display screen on which to display the image, the deeper side being a side which is away from a driver; and
a sensor section configured to specify a location of a face of the driver; and
a parallax barrier configured to shield a part of each of the right eye image and the left eye image from light in accordance with the location of the face of the driver, the location having been specified by the sensor section, so that the visible object is recognized to be located on the deeper side than the display screen.

6. An electronic mirror comprising:
a display device recited in claim 4; and
a photographing section configured to (i) capture an image of a rear center, a left rear, or a right rear of a vehicle and (ii) supply the image thus captured to the display device.

7. A display device as set forth in claim 2, further comprising:
an image display section configured to display a right eye image and a left eye image of the visible object; and
a parallax barrier configured to shield a part of each of the right eye image and the left eye image from light so that the visible object is recognized to be located on the deeper side than the display screen.

8. An electronic mirror comprising:
a display device recited in claim 7; and
a photographing section configured to (i) capture an image of a rear center, a left rear, or a right rear of a vehicle and (ii) supply the image thus captured to the display device.

9. An electronic mirror comprising:
a display device recited in claim 5; and
a photographing section configured to (i) capture an image of a rear center, a left rear, or a right rear of a vehicle and (ii) supply the image thus captured to the display device.
